(19) United States
(12) Patent Application Publication
(10) Pub. No.: US 2004/0148729 A1
(43) Pub. Date: Aug. 5, 2004

(54) Paint brush holder

(76) Inventor: Nicholas F. Fawcett, Lytham St. Annes (GB)

Correspondence Address: Kenneth P. Glynn, Esq., Glynn & Associates, P.C., 24 Mine Street, Flemington, NJ, 08822, US

(21) Appl. No.: 10/761,090

(22) Filed: Jan. 20, 2004

(30) Foreign Application Priority Data
Jan. 22, 2003 (GB) 0301435.4
Feb. 17, 2003 (GB) 0303554.0

(51) Int. Cl. B05C 21/00

(52) U.S. Cl. 15/257.05; 15/257.06

(57) ABSTRACT

The Paint Brush Holder is attached to a paint can by means of a clasp or clip 4, it is further stabalised by a exterior cresent shaped bumper 3. A paint brush placed in the holder 1 and rests against the interior “tear drop” bumpers 5 which are dragged against by the brush to remove paint when removed, the excess paint is drained through holes at the base 6 into a detachable tray 2 which is removed downwards by applying pressure to both sides to release for cleaning.

### PRIORITY CLAIM

Applicant hereby claims form priority benefits under 35 USC 119 based on British Patent Application Number 0301435.4, filed on 22 Jan. 2003, entitled “Pain Brush Holder”, by Nicholas F. Fawcett, the inventor herein, and based on British Patent Application Number GB 0303554.0 filed on 17 Feb. 2003, entitled “Pain Brush Holder”, by Nicholas F. Fawcett, the inventor herein.

### SUMMARY OF THE INVENTION

The Paint Brush Holder is attached to a paint can by means of a clasp or clip 4, it is further stabalised by a exterior cresent shaped bumper 3. A paint brush placed in the holder 1 and rests against the interior “tear drop” bumpers 5 which are dragged against by the brush to remove paint when removed, the excess paint is drained through holes at the base 6 into a detachable tray 2 which is removed downwards by applying pressure to both sides to release for cleaning.

### BRIEF DESCRIPTION OF THE DRAWINGS

The present invention should be more fully understood when the specification herein is taken in conjunction with the drawings appended hereto wherein:

FIG. 1. Shows in perspective the holder in a up-right position.

FIG. 2. Illustrates an internal view of how the excess paint is drained through holes into the detachable tray.

FIG. 3. Illustrates a two dimensional back view.

FIG. 4. Top view illustrating “tear drop” bumpers, holes into the detachable drip tray and front bumper.

### DETAILED DESCRIPTION OF THE PRESENT INVENTION

This invention relates to a Paint Brush Holder. The Paint Brush Holder is designed to provide a safe and drip free resting place for the in-use brush whilst in between painting and a hands free climb up ladders. The invention came about by numerous accidents where the brush would fall constantly on carpets, off ladders and in the paint can itself.

A specific embodiment of the invention now be described by way of example with reference to the accompanying drawing in which:

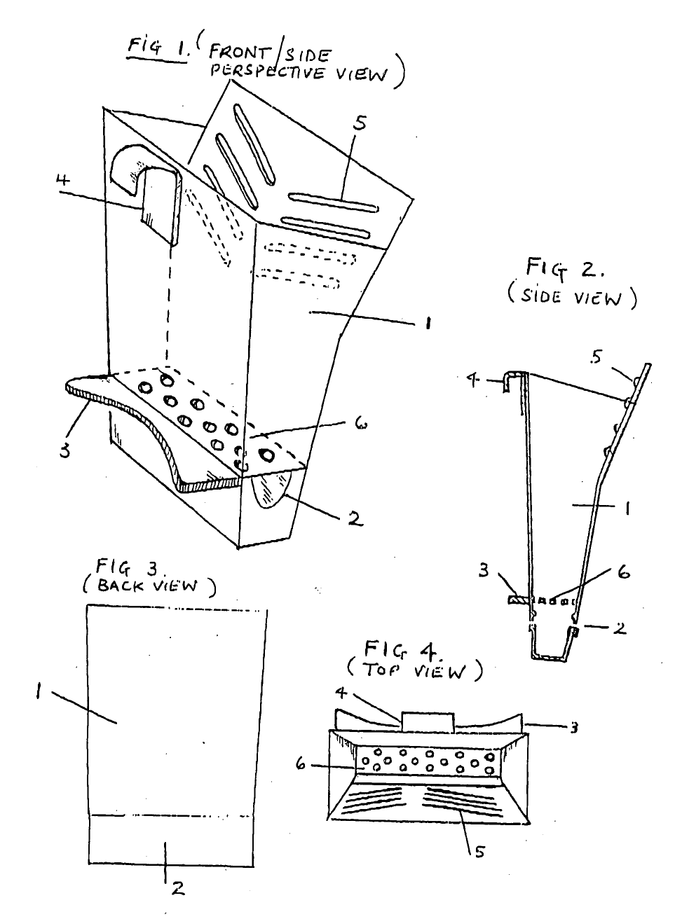

FIG. 1. Shows in perspective the holder in a up-right position.

FIG. 2. Illustrates an internal view of how the excess paint is drained through holes into the detachable tray.

FIG. 3. Illustrates a two dimensional back view.

FIG. 4. Top view illustrating “tear drop” bumpers, holes into the detachable drip tray and front bumper.

The Paint Brush Holder comprises of a wedge shaped durable plastic container which designed to clip (FIG. 1.4) onto a paint can by means of a clasp. The paint brush rests inside the holder (FIG. 1.1) where any excess paint can drain through holes (FIG. 2.6) at the base into the detachable drip tray (FIG. 1.2). The tray is released by applying pressure to both sides and pulling downwards (FIG. 2.7) to enable the user to clean it. Interior “tear drop” shape bumpers (FIG. 1.5) are designed to drag any surplus paint off the brush when retrieving it. An exterior crescent shaped bumper adds stability to the holder (FIG. 1.3).

What is claimed is:

1. A Paint Brush Holder comprising a generally wedge-shaped container having means for clipping to the rim of paint can and including a drip tray forming a base which can be removed for cleaning.

2. The Paint Brush Holder as claimed in claim 1. which has interior tear drop bumpers to drag excess paint from the brush placed on the top half of the back inside wall.

3. The Paint Brush Holder as claimed in claim 1. which has a member having holes defining a grid above the base to allow paint to drip through.

4. The Paint Brush Holder as claimed in claim 2. which has a release mechanism to both sides to allow removal of the detachable drip tray.

5. The Paint Brush Holder as claimed in claim 3. which has a release mechanism to both sides to allow removal of the detachable drip tray.

5. The Paint Brush Holder as claimed in claim 4. which has an exterior half-moon shaped bumper attached to the highest part of the front wall to the detachable drip tray.

6. A Paint Brush Holder as claimed in claim 1. which is made exclusively to house a paint brush.

7. A Paint Brush Holder as claimed in claim 2. which is made exclusively to house a paint brush.

8. A Paint Brush Holder as claimed in claim 3. which is made exclusively to house a paint brush.

9. A Paint Brush Holder as claimed in claim 4. which is made exclusively to house a paint brush.

10. A Paint Brush Holder as claimed in claim 5. which is made exclusively to house a paint brush.

11. A Paint Brush Holder as claimed in claim 1. which is made from metal, plastic material or wood or from any combination of the these materials.

12. A Paint Brush Holder as claimed in claim 2. which is made from metal, plastic material or wood or from any combination of the these materials.

13. A Paint Brush Holder as claimed in claim 3. which is made from metal, plastic material or wood or from any combination of the these materials.

14. A Paint Brush Holder as claimed in claim 4. which is made from metal, plastic material or wood or from any combination of the these materials.

15. A Paint Brush Holder as claimed in claim 5. which is made from metal, plastic material or wood or from any combination of the these materials.

16. A Paint Brush Holder as claimed in claim 6. which is made from metal, plastic material or wood or from any combination of the these materials.

17. A Paint Brush Holder as claimed in claim 7. which is made from metal, plastic material or wood or from any combination of the these materials.

18. A Paint Brush Holder as claimed in claim 8. which is made from metal, plastic material or wood or from any combination of the these materials.

19. A Paint Brush Holder as claimed in claim 9. which is made from metal, plastic material or wood or from any combination of the these materials.

20. A Paint Brush Holder substantially as herein described and illustrated in the accompanying drawings.
